(19) United States
(12) Patent Application Publication
(10) Pub. No.: US 2025/0371547 A1
(43) Pub. Date: Dec. 4, 2025

(54) FINANCIAL TRANSACTION FRAUD PREVENTION SYSTEM USING HYSTERESIS MODELS, DECISION TREES, AND TRANSFORMER NETWORKS

(71) Applicant: GiveCorporation, Inc., Scottsdale, AZ (US)

(72) Inventors: Joshua Rowley, Hermosa Beach, CA (US); Aaron Miller, Mytne Ludany (SK)

(73) Assignee: GiveCorporation, Inc., Scottsdale, AZ (US)

(21) Appl. No.: 18/679,327

(22) Filed: May 30, 2024

(51) Int. Cl. G06Q 20/40

(52) U.S. Cl. CPC G06Q 20/4016

(57) ABSTRACT

A fraud detection system preemptively identifies and mitigates fraudulent financial transactions in real-time across a diverse range of digital and physical transaction sources. Transaction data may be acquired from various platforms and categorized into rule sets specific to transaction types. Categorized data is aligned with existing risk profiles to construct a dynamic hysteresis model. This model, evaluated by a decision tree algorithm, identifies potential fraud by integrating immediate transaction details with a comprehensive historical data analysis, thus enabling advanced trend analysis and pattern recognition. Key features identified by the decision tree are used to form a heuristics model, which is then analyzed by a transformer network risk model. A feedback loop enhances the system's effectiveness by incorporating decision outcomes back into the model training server, thus refining the training dataset and continuously improving the accuracy of the risk model.

### BACKGROUND

The vast and growing reliance on electronic transactions has created vast and growing new avenues for fraud. Payment processors and other participants in the financial system use automated systems to detect various types of fraud in payment systems, but existing systems cannot reliably evaluate transactions quickly enough to provide a determination of fraud risk in an acceptable interval between presentation of a payment method (e.g., a credit or debit card) and completion of the transaction. Sellers and others thus often face a choice between delaying completion of the transaction—and possibly driving away customers—or bearing an unacceptably high risk of fraud.

For these reasons, there is a need for systems and methods that can provide a reliable estimate of fraud risk in real time to the point of sale or other interface related to a transaction.

### BRIEF SUMMARY

A novel fraud detection system according to embodiments of the invention is designed to preemptively identify and mitigate fraudulent financial transactions in real-time across a diverse range of digital and physical transaction sources. In embodiments, the process may begin with the acquisition of transaction data from various platforms, including, e.g., websites, APIs, mobile applications, digital marketplaces, social media, e-commerce sites, subscription services, email campaigns, and POS systems. This data is may then be transmitted, e.g., to an application server, where it may be categorized into rule sets tailored for specific transaction types, such as E-commerce and POS transactions.

Upon categorization, the data may be aligned with existing risk profiles stored in a database, facilitating the construction of a dynamic hysteresis model. This model, evaluated by a decision tree algorithm, may, e.g., identify potential fraud by integrating immediate transaction details with a comprehensive historical data analysis, thus enabling advanced trend analysis and pattern recognition. Key features identified by the decision tree may be used to form a heuristics model, which may then be analyzed by, e.g., a transformer network risk model known for its effectiveness in sequence analysis.

In embodiments of the invention, the system may employ a decision interpreter algorithm to synthesize and evaluate the outputs from both the decision tree and transformer network, e.g., by applying a weighted analysis to reach a final decision on the transaction's risk level. This may include, for example, considering various risk factors and applying bias adjustments as necessary to address specific threats. The outcome of this decision may then influence the subsequent action on the transaction-allowing, blocking, or quarantining it, as deemed appropriate.

A feedback loop may enhance the system's effectiveness, e.g., by incorporating decision outcomes back into the model training server, thus refining the training dataset and continuously improving the accuracy of the risk model.

An integrated decision-making pipeline according to embodiments of the invention may thus offer a comprehensive, data-driven approach to fraud detection. By analyzing transactions at various lifecycle stages with sophisticated analytical models, embodiments may not only identify and prevent fraud before fund flow but also adapt to emerging trends, significantly reducing risks and financial losses.

According to an embodiment of the invention, a computer-implemented method of real-time fraud prevention uses a fraud prevention system on a transaction. The method comprises: accessing real-time data from a device, by a central processing unit (CPU) of an application server of an integrated decision engine, from a device; processing a risk profile input and the real-time data by a decision tree model located in the application server to generate a decision tree model output; constructing a heuristics model by the CPU of the application server by synthesizing the decision tree model output with historical data; processing the heuristics model and decision tree model output by the decision tree model located in the application server to generate a structured narrative; providing the structured narrative from the application server to a predictive server comprising a transformer network and a predictive risk model via a network interface; generating a prediction by processing the structured narrative using the predictive risk model located in the predictive server; processing the structured narrative and the prediction by the CPU of the application server to generate a decision; and providing the decision to the device.

According to an embodiment, the method further comprises evaluating the decision tree model output by a hysteresis model located in the CPU of the application server to generate a hysteresis model output; updating the heuristics model located in the CPU of the application server, with the hysteresis model output; and saving the heuristics model to a memory of the application server. According to an embodiment, the method comprises processing the real-time data by one or more steps from the group consisting of: determining a source of the real-time data using a source detector and providing a source rule-set based on the source to the application server of the integrated decision engine, cleaning the real-time data, transforming the real-time data, and extracting features from the real-time data.

According to an embodiment, the real-time data comprises identity data; and the risk profile input is generated by a method comprising determining a user profile by creating a new user profile from the identity data or matching the identity data to an existing user profile stored in a database of the application server, processing the real-time data, identity data, historical data, and the user profile by a risk profiler to generate a risk profile, wherein the risk profile comprises a risk level, wherein the risk level comprises a low risk level, a medium risk level, or a high risk level, and combining the risk profile and the heuristics model.

According to an embodiment, the method comprises dynamically evaluating the hysteresis model by one or more steps from the group consisting of evaluating a risk level of the hysteresis model; verifying the hysteresis model contextually; and analyzing a trend in the hysteresis model by a method that comprises recognizing a pattern, generating a transformer prediction decision by providing the pattern to the transformer network of the predictive server, generating a decision tree prediction decision by providing the pattern to a decision tree predictor in the CPU of the application server, combining the transformer prediction decision and the decision tree prediction decision using a decision interpreter to generate a trend decision, comprising an escalating trend decision, or a non-escalating trend decision. In the method, the escalating trend decision applies a bias to a risk level action, in the processing of the heuristics model and the prediction by the CPU of the application server, and wherein the non-escalating trend decision applies the risk level action, in the processing of the heuristics model and the prediction by the CPU of the application server.

According to an embodiment, the predictive risk model comprises a trained risk model, wherein the trained risk model is generated by a method comprising: transmitting an output from a Generational Adversarial Network (GAN) located on a simulated data server to a simulated data on the simulated data server to generate a simulated data server output; inputting the simulated data server output into a training dataset on a model training server; pre-processing the training dataset to generate a pre-processed training dataset; batching the pre-processed training dataset with processed data by a CPU of the model training server to generate a batched dataset; transmitting the batched dataset to a transformer training engine located on the Graphics Processing Unit (GPU) of the model training server; processing the batched dataset by the transformer training engine located on the GPU of the model training server to generate an epoch of a model; processing the epoch of the model to generate the trained risk model; transmitting the trained risk model to the database of the predictive server; and combining the trained risk model with the predictive risk model.

According to an embodiment, the simulated data server output is generated by a method comprising: loading historical data to a historical training dataset located on the simulated data server; performing data pre-processing on the historical training dataset by the CPU of the simulated data server to generate a pre-processed training dataset; transmitting processed data from a memory of the simulated data server to the CPU of the model training server; batching the processed data and pre-processed training dataset by the CPU of the simulated data server to generate a batched dataset of the simulated data server; transmitting the batched dataset of the simulated data server to a GPU of the simulated data server; processing the batched dataset by a GAN located on the GPU of the simulated data server to generate an output from the GAN located on the simulated data server; and transmitting the output from the located on the simulated data server to a simulated data on the simulated data server to generate the simulated data server output.

According to an embodiment, the GAN located on the simulated data server comprises a GAN regularization engine, wherein the GAN regularization engine comprises a discriminator and a generator, and the GAN located on the simulated data server is trained by a method comprising: processing historical transaction data on a data pre-processing engine to generate a pre-processed historical transaction dataset; refining the pre-processed historical transaction dataset by the discriminator to generate a refined GAN regularization data engine; generating a simulated data set by the generator of the GAN regularization engine; repeating the refining by the discriminator on the simulated data and generation of simulated data by generator until a high quality simulated transaction dataset is output by the GAN; transmitting the high quality simulated transaction dataset to the transformer network; processing the high quality simulated transaction dataset to generate a simulated transformer prediction; providing the simulated transformer prediction to the data pre-processing engine; performing data pre-processing on historical transaction data and the simulated transformer prediction; and repeating the GAN located on the simulated data server training process using a feedback loop.

According to an embodiment, the method comprises performing a transformer training process by a method comprising transmitting the high quality simulated transaction dataset to the model training server, performing data pre-processing on the high quality simulated transaction dataset to generate a pre-processed simulated transaction dataset, transmitting the pre-processed simulated transaction dataset to a training model of the transformer training engine located on the GPU of the model training server to perform a transformer training engine process, repeating the transformer training engine process until the target of the transformer training engine is reached and then transmitting the updated training model to the predictive risk model of the predictive server, generating the prediction from the predictive server by a method comprising processing the structure narrative by the CPU of the predictive server by applying the predictive server comprising the updated training model, providing the prediction to the application server, processing the structured narrative and the prediction by the CPU of the application server to generate the decision, performing an outcome analysis on the decision to generate an outcome analysis output, and performing data pre-processing on the high quality simulated transaction dataset and the outcome analysis output. According to the embodiment, the method further comprises repeating the transformer training process using a transformer training process feedback loop.

According to an embodiment, the transformer training engine process comprises: passing forward the pre-processed simulated transaction dataset from the training model to one or more layers of the transformer training engine; generating an output from the one or more layers of the transformer training engine; comparing the output from the one or more layers against a target of the transformer training engine to calculate a loss; generating an optimized backpropagation by inputting the loss into an optimizer; backpropagating the optimized backpropagation to one or more weights of the transformer training engine to generate one or more updated weights; and updating the training model of the transformer training engine with the one or more updated weights to generate an updated training model.

According to an embodiment, the method comprises processing the hysteresis model output before updating the heuristics model by one or more steps from the group consisting of: cleaning the hysteresis model output; tokenizing the hysteresis model output; transforming the hysteresis model output; and vectorizing the hysteresis model output. According to an embodiment, generating the prediction by processing the structured narrative using the predictive risk model located in the predictive server comprises building a vector model by one or more steps from the group consisting of: processing sequential layers of the structured narrative; processing the structured narrative using a self-attention mechanism; and transforming layers of the structured narrative.

According to an embodiment, the method comprises processing the decision to generate response by one or more steps from the group consisting of: decoding the decision; interpreting the decision; thresholding the decision; applying rules to the decision; and summarizing the decision. According to an embodiment, the method comprises generating a final decision, wherein the final decision comprises an escalating final decision, a non-escalating final decision, or a de-escalating final decision, generated by the integrated decision engine by a method comprising evaluating a weighted decision tree decision against a weighted transformer network decision by a method comprising comparing a weight of the weighted decision tree decision against a weight of the weighted transformer network decision, and providing the final decision to the device.

According to an embodiment, the weighted decision tree decision is generated by a method comprising: transmitting the real-time data to the hysteresis model; generating a real-time data hysteresis model output by processing the real-time data in the hysteresis model located in the CPU of the application server; and processing the real-time data hysteresis model output by applying decision tree analysis to generate the weighted decision tree decision.

According to an embodiment, the weighted transformer network decision is generated by a method comprising: transmitting the weighted decision tree decision to the heuristics model; generating a weighted decision heuristics model output by processing the weighted decision tree decision in the heuristics model located in the CPU of the application server; transmitting the weighted decision heuristics model output to the transformer network of the predictive server; and processing the weighted decision heuristics model output by applying transformer network analysis to generate the weighted transformer network decision. According to an embodiment, the weight of the weighted decision tree decision is generated by comparing the weighted decision tree decision to the decision.

According to an embodiment, the method comprises applying a risk level action to the risk level of the risk profile. The risk level action comprises increasing, decreasing, or maintaining the risk level, by a method comprising: transmitting the final decision to the risk profile in the database of the application server; comparing the final decision to the risk profile; and generating the risk level action.

According to an embodiment, the method comprises providing the decision from the application server to the device comprises a decision action, wherein: the decision action comprises allowing, quarantining, or blocking the transaction; and increasing or decreasing the risk level of the risk profile changes the decision action. According to an embodiment, the method comprises evaluating the integrated decision engine by generating a feedback dataset; integrating the feedback dataset by generating an integrated decision engine update; and adjusting the integrated decision engine using the decision engine.

According to an embodiment, the feedback dataset is generated by a method comprising: comparing the final decision, weighted decision tree decision, and weighted transformer network decision to determine if the final decision was accurate; and comparing a subsequent transaction comprising a subsequent decision or a subsequent final decision to the final decision, weighted decision tree decision, and weighted transformer network decision to determine if a the subsequent decision or subsequent final decision were accurate.

According to an embodiment, the integrated decision engine update is generated by a method comprising: labelling the feedback dataset; curating the feedback dataset; performing data pre-processing on the feedback dataset; and augmenting the training dataset on the model training server.

According to an embodiment, the integrated decision engine is adjusted using the decision engine update by a method comprising: adjusting the weight of the weighted decision tree decision; adjusting the weight of the weighted transformer network decision; and retraining the model.

According to an embodiment, the method comprises determining the source by the source detector, wherein the source comprises a Point-of-Sale (POS) source or an E-commerce source.

According to an embodiment, the pattern comprises one or more blocks with a low amount, one or more blocks with a high amount, a plurality of blocks on a plurality of devices, or one or more blocks.

According to an embodiment, constructing the heuristics model comprises generating a set of heuristics model features, wherein the set of heuristics model features comprises a transaction geolocation, a merchant location, a card issuing location, an email rejection amount, an escalation reason, a current risk level, or a number of order items.

### BRIEF DESCRIPTION OF THE FIGURES

FIG. 1 depicts an illustrative fraud prevention system according to an embodiment of the invention.

FIG. 2 depicts an application server according to embodiments of the invention.

FIG. 3 depicts a predictive server according to embodiments of the invention.

FIG. 4 depicts a model training server according to embodiments of the invention.

FIG. 5 depicts a simulated data server according to embodiments of the invention.

FIG. 6 depicts the flow of a fraud prevention system for real-time fraud prevention according to embodiments of the invention.

FIG. 7 depicts generation of a risk profile and combination of that risk profile with a heuristic model according to embodiments of the invention.

FIG. 8 depicts construction of a hysteresis model according to an embodiment of the invention.

FIG. 9 depicts generating and/or updating a heuristics model according to an embodiment of the invention.

### DETAILED DESCRIPTION OF PREFERRED EMBODIMENTS

This disclosure may define certain terms. Unless required by context or explicitly stated otherwise, any such definitions are given solely for identification, illustration, or both. Thus, all terms are used according to their ordinary meanings in the relevant arts, again, unless required by context or explicitly stated otherwise.

The phrase “an embodiment” as used herein does not necessarily refer to the same embodiment, though it may. In addition, the meaning of “a,” “an,” and “the” include plural references; thus, for example, “an embodiment” is not limited to a single embodiment but refers to one or more embodiments. Similarly, the phrase “one embodiment” does not necessarily refer to the same embodiment and is not limited to a single embodiment. As used herein, the term “or” is an inclusive “or” operator and is equivalent to the term “and/or,” unless the context clearly dictates otherwise. And, more specifically, the term “and/or” between multiple recited elements is understood as encompassing each combination of at least one element. For instance, “A and/or B” embraces each of A alone, B alone, and both A and B. Likewise, “A, B, and/or C” embraces each of seven combinations comprising at least one of A, B, and C. The term “based on” is not exclusive and allows for being based on additional factors not described unless the context clearly dictates otherwise.

In addition, as used herein, “automatically” generally refers to occurring, or being capable of occurring, without requiring being invoked or initiated by and/or in response to a human action, unless the context clearly dictates otherwise.

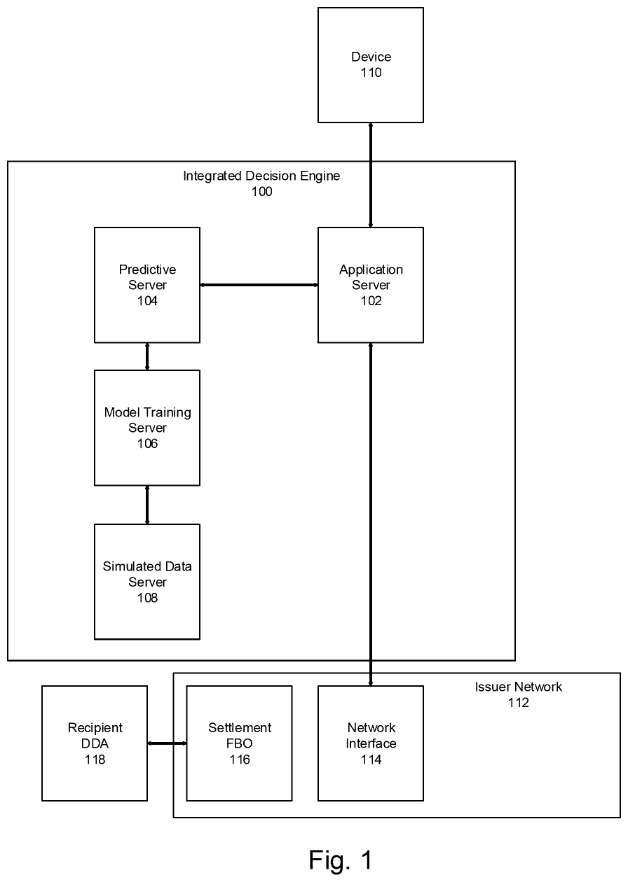

FIG. 1 depicts a simplified block-type diagram of an illustrative fraud prevention system that may be implemented for generating a decision on a transaction using a computer-implemented method of real-time fraud prevention. As shown, the fraud prevention system comprises an integrated decision engine 100 which comprises an application server 102, a predictive server 104, a model training server 106, and a simulated data server 108. Although the integrated decision engine 100 is presented in one arrangement, other embodiments may include a part or parts of the integrated decision engine 100 and/or additional parts which may be arranged differently from the integrated decision engine shown in FIG. 1.

The application server 102 is communicably coupled via a network connection with the predictive server 104, a remote device 110, and an issuer network 112. The predictive server 104 is communicably coupled via a network connection with a model training server 106. The model training server 106 is communicably coupled via a network connection with a simulated data server 108. The remote device 110 is communicably coupled via a network connection with the integrated decision engine 100. The remote device 110, for example, may comprise a mobile phone, tablet, laptop computer, personal computer, merchant computer, merchant payment terminal, and/or any other such device that may be used in a transaction. The issuer network 112, for example, may comprise a network interface 114 and a settlement for benefit of (FBO) 116 account. The issuer network 112, for example, may be communicably coupled via a network connection with the integrated decision engine 100 and a recipient demand deposit account (DDA) 118.

A network connection generally comprises any combination of one or more public and/or private wired and/or wireless networks, including the Internet, a cellular network, an intranet, an extranet, a wide-area network (WAN), a local-area network LAN, or any other network configuration as well as any associated communication protocols. More specifically, a network connection may comprise the Internet and any other wired and/or wireless network(s) that provide a network configuration to enable any of the communications (e.g., transfer of data and commands) that may be required based on embodiments in accordance with the present disclosure.

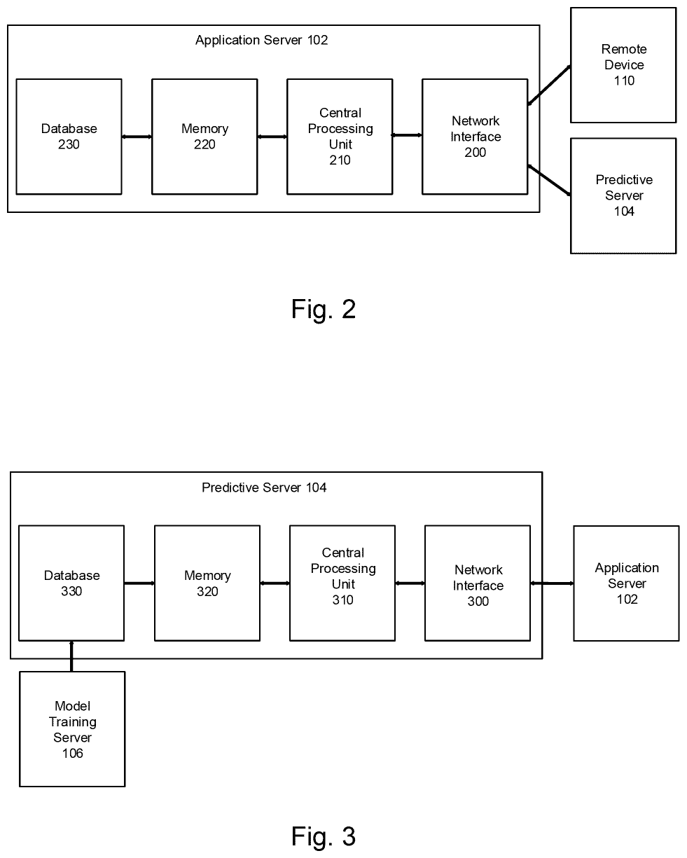

FIG. 2 depicts a simplified block-type diagram of the application server 102 in accordance with some embodiments. As shown, the application server 102 comprises a network interface 200, a central processing unit (CPU) 210, a memory 220, and a database 230. The network interface 200 of the application server 102 is communicably coupled via a network connection with the predictive server 104 and the remote device 110. The CPU 210, for example may comprise at least one processor core or a plurality of processor cores. The memory 220, for example, may comprise Random Access Memory (RAM), as well as a non-volatile memory, such as NOR flash memory, and solid-state storage, such as NAND flash-based storage. As may be appreciated, RAM and flash memory may be implemented as separate integrated circuit chips coupled to communicate with CPU 210, and CPU 210 may in some embodiments include on-chip RAM (e.g., cache) and, possibly, on-chip flash memory in some implementations. The database 230, for example, may comprise one or more hard disk drives.

As depicted in FIG. 2, the one or more components of the application server 102 may communicate with one another. For example, the network interface 200 may communicate with the central processing unit 210. For example, the central processing unit 210 may communicate with the network interface 200 and the memory 220. For example, the memory 220 may communicate with the central processing unit 210 and the database 230. For example, the database 230 may communicate with the memory 220.

The network interface 200 may be operable to receive real-time data from the remote device 110. The network interface 200, for example, may transmit real-time data, a decision, a to the CPU 210 of the of the application server. The network interface 200, for example, may provide, output, and/or communicate a decision to the remote device 110. The network interface 200, for example, may provide, output, and/or communicate a heuristics model to the predictive server.

FIG. 3 depicts a simplified block-type diagram of the predictive server 104 in accordance with some embodiments. As shown, the predictive server 104 comprises a network interface 300, a central processing unit (CPU) 310, a memory 320, and a database 330. The one or more components of the predictive server 104 may communicate with one another. The network interface 300 of the predictive server 104 is communicably coupled via a network connection with the application server 102. The CPU 310, for example may comprise at least one processor core or a plurality of processor cores. The memory 320, for example, may comprise Random Access Memory (RAM), as well as a non-volatile memory, such as NOR flash memory, and solid-state storage, such as NAND flash-based storage. As may be appreciated, RAM and flash memory may be implemented as separate integrated circuit chips coupled to communicate with CPU 310, and CPU 310 may in some embodiments include on-chip RAM (e.g., cache) and, possibly, on-chip flash memory in some implementations.

The database 330, for example, may comprise data stored, e.g., on one or more hard disk drives, solid state drives, and/or other media and/or devices. (Depending on the context, “the database” may refer, e.g., to the stored data or to the storage devices that are encoded with the stored data.) The database 330 of the predictive server 104 is communicably coupled via a network connection with the model training server 106.

As depicted in FIG. 3, the one or more components of the predictive server 104 may communicate with one another. For example, the network interface 300 may communicate with the central processing unit 310. For example, the central processing unit 310 may communicate with the network interface 300 and the memory 320. For example, the memory 320 may communicate with the central processing unit 310 and the database 330. For example, the database 330 may communicate with the memory 320.

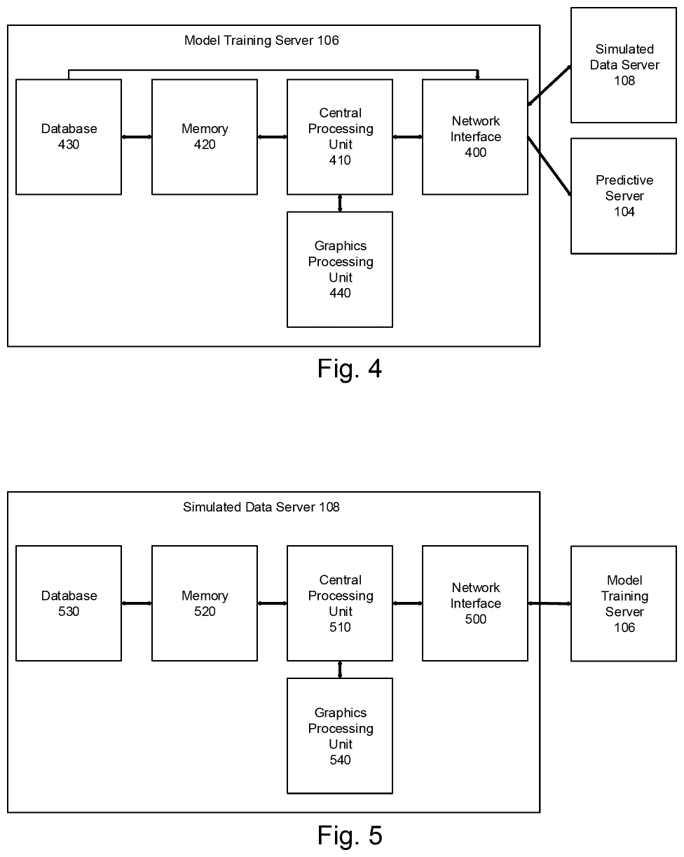

FIG. 4 depicts a simplified block-type diagram of the model training server 106 in accordance with some embodiments. As shown, the model training server 106 comprises a network interface 400, a central processing unit (CPU) 410, a memory 420, a database 430, and a graphics processing unit (GPU) 440. The CPU 410, for example may comprise at least one processor core or a plurality of processor cores. The memory 420, for example, may comprise Random Access Memory (RAM), as well as a non-volatile memory, such as NOR flash memory, and solid-state storage, such as NAND flash-based storage. As may be appreciated, RAM and flash memory may be implemented as separate integrated circuit chips coupled to communicate with CPU 410, and CPU 410 may in some embodiments include on-chip RAM (e.g., cache) and, possibly, on-chip flash memory in some implementations. The database 430, for example, may comprise one or more hard disk drives.

As depicted in FIG. 4, the one or more components of the model training server 106 may communicate with one another. For example, the network interface 400 may communicate with the central processing unit 410. For example, the central processing unit 410 may communicate with the network interface 400, the memory 420, and the graphics processing unit 440. For example, the graphics processing unit 440 may communicate with the central processing unit 410. For example, the memory 420 may communicate with the central processing unit 410 and the database 430. For example, the database 430 may communicate with the network interface 400 and the memory 420.

FIG. 5 depicts a simplified block-type diagram of the simulated data server 108 in accordance with some embodiments. As shown, the simulated data server 108 comprises a network interface 500, a central processing unit (CPU) 510, a memory 520, a database 530, and a graphics processing unit (GPU) 540. The CPU 510, for example may comprise at least one processor core or a plurality of processor cores. The memory 520, for example, may comprise Random Access Memory (RAM), as well as a non-volatile memory, such as NOR flash memory, and solid-state storage, such as NAND flash-based storage. As may be appreciated, RAM and flash memory may be implemented as separate integrated circuit chips coupled to communicate with CPU 510, and CPU 510 may in some embodiments include on-chip RAM (e.g., cache) and, possibly, on-chip flash memory in some implementations. The database 530, for example, may comprise one or more hard disk drives.

As depicted in FIG. 5, the one or more components of the simulated data server 108 may communicate with one another. For example, the network interface 500 may communicate with the central processing unit 510. For example, the central processing unit 510 may communicate with the network interface 500, the memory 520, and the graphics processing unit 540. For example, the graphics processing unit 540 may communicate with the central processing unit 510. For example, the memory 520 may communicate with the central processing unit 510 and the database 530. For example, the database 530 may communicate with the memory 520.

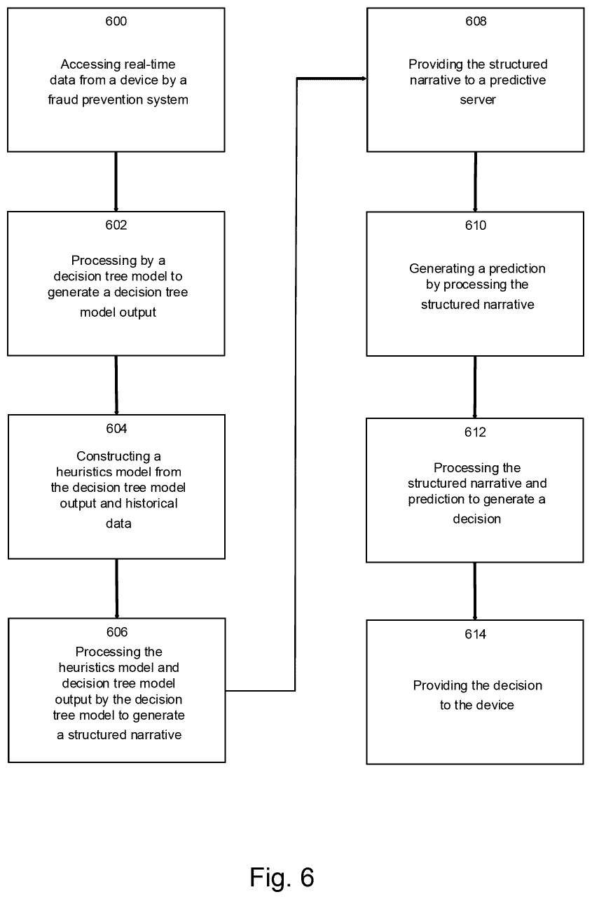

FIG. 6 depicts a high-level, illustrative flowchart showing steps/actions performed by a fraud prevention system running on an integrated decision engine for real-time fraud prevention, in accordance with some embodiments. For clarity of exposition of various features and advantages that may be provided according to various embodiments, it is presumed that the models, networks, interpreter, and/or other code is already stored in the fraud prevention system, integrated decision engine, server, database, memory, CPU, and/or GPU, and being executed by one or more processors.

Referring to FIG. 6, real-time data is received by the fraud prevention system 100 from the device 110. The real-time data, for example, may be received by the integrated decision engine 100, the application server 102, and/or the network interface 200 of the application server 102. In, step 600, the real-time data is accessed by the CPU 210 of the application server 102 of the integrated decision engine 100.

The real-time data, for example, may comprise a real-time data source, transaction data, identity data, metadata from a transaction request, parameters of an application programming interface, merchant category codes, transaction amounts, recent transaction declines, geolocation data, internet protocol (IP) address, cookies, cookie headers, payment method specifics, cryptocurrency network wallet address, blockchain wallet address, Automated Clearing House (ACH) transaction identifications, ACH routing numbers, FedNow transaction identifications, FedNow routing numbers, credit cardholder name, debit cardholder name and/or time between sequential transaction requests. The real-time data source, for example, may comprise one or more: payment channels, digital retail platforms, physical retail platforms, online banking portals, credit card transactions, debit card transactions, ACH transactions, FedNow transactions, blockchain transactions, cryptocurrency transactions, web transactions, web application transactions, mobile device transactions, and/or mobile device application transactions.

In step 602, the real-time data and risk profile inputs are processed by a decision tree model located in the application server 102 to generate a decision tree model output. The decision tree model, for example, may comprise a decision tree algorithm and/or decision tree analysis tasks. The decision tree model, for example, may be located on the database 230 and/or memory 220 of the application server 102. The processing by the decision tree model, for example, may be performed on the CPU 210 of the application server 102. The decision tree model output, for example, may comprise one or more: decision tree heuristics, decision tree predictions, decision tree risk score, decision tree risk level, and/or decision tree decisions.

The decision tree model, for example, may comprise one or more: root nodes, leaf nodes, and/or branching criteria. The one or more root nodes, for example, may be selected based upon the feature with the highest information gain among the real-time and historical data. The one or more leaf nodes, for example, may be selected by a comparison between risk scores. The branching criteria, for example, may comprise sequence based criteria (e.g., total amount of those declined transactions). The decision tree model, for example, may be pruned to prevent overfitting and thereby remain generalizable to new transactions.

In step 604, a heuristics model is constructed by the CPU 210 of the application server 102 by synthesizing the decision tree model output with historical data. The heuristics model, for example, may be constructed by the CPU 210 of the application server 102 by synthesizing the decision tree model output with historical data and a hysteresis model output. The heuristics model, for example, may be refined by one or more heuristics model refinement algorithms. The one or more heuristics model refinement algorithms may dynamically adjust the heuristics model by adjusting the heuristics model weights, adjusting the heuristics model features, heuristics model feedback loop, and/or iterative heuristics model construction. The historical data, for example, may comprise one or more: historical patterns, geographical discrepancies, payment method anomalies, patterns of decline, and/or transaction amounts.

The heuristics model, for example, may comprise one or more: heuristics model feature types, heuristics model features, and/or heuristics model feature attributes. The one or more heuristics model feature types, for example, may comprise one or more: transaction details, model outputs, historical data, external data, and/or behavioral change. The one or more heuristics model features, for example, may comprise one or more: IP addresses, heuristics model risk score, heuristics model risk level, transaction amounts, transaction declines per a time period, geographical discrepancies, payment method details, merchant categories, merchant interactions, failed email validations, user agent diversities, changes in payment method per a time period, and/or decline patterns.

The one or more transaction amounts, for example may comprise historical transaction amount averages. The one or more transaction declines per a time period, for example, may comprise one or more: transaction declines and/or one or more transaction decline time periods. The one or more transaction declines, for example, may comprise, one transaction decline, two transaction declines, three transaction declines, four transaction declines, five transaction declines, and/or a plurality of transaction declines. The one or more transaction decline time periods, for example, may comprise one minute, five minutes, thirty minutes, a plurality of minutes, one hour, eight hours, twelve hours, a plurality of hours, one day, a plurality of days, one week, a plurality of weeks, one month, a plurality of months, one year, a plurality of years, and/or a time period between any two transaction decline periods provided herein.

The one or more geographical discrepancies, for example, may comprise one or more: virtual private network (VPN) usages, geolocation mismatches, and/or geolocation risk scores. The one or more payment method details, for example, may comprise one or more: payment methods. The one or more payment methods, for example, may comprise one or more: prepaid cards, debit cards, and/or credit cards. The one or more merchant categories, for example, may comprise one or more: merchant category codes (MCCs), and/or an MCC risk score. The one or more merchant interactions, for example, may comprise one or more: merchant frequency patterns and/or merchant diversity patterns. The one or more failed email validations, for example, may comprise, one failed email validation, two failed email validations, three failed email validations, four failed email validations, five failed email validations, and/or a plurality of failed email validations. The one or more user agent diversities, for example, may comprise, one user agent, two user agents, three user agents, four user agents, five user agents, and/or a plurality of user agents.

The one or more changes in payment method per a time period, for example, may comprise one or more: changes in payment methods and/or one or more payment method change time periods. The one or more changes in payment methods, for example, may comprise, one change in payment methods, two changes in payment methods, three changes in payment methods, four changes in payment methods, five changes in payment methods, and/or a plurality of changes in payment methods. The one or more payment method change time periods, for example, may comprise one minute, five minutes, thirty minutes, a plurality of minutes, one hour, eight hours, twelve hours, a plurality of hours, one day, a plurality of days, one week, a plurality of weeks, one month, a plurality of months, one year, a plurality of years, and/or a time period between any two payment method change time periods provided herein. The one or more changes in payment method change patterns, for example, may comprise one or more: transaction declines and/or one or more transaction decline time periods.

The one or more transaction declines, for example, may comprise, one transaction decline, two transaction declines, three transaction declines, four transaction declines, five transaction declines, and/or a plurality of transaction declines. The one or more transaction decline time periods, for example, may comprise one minute, five minutes, thirty minutes, a plurality of minutes, one hour, eight hours, twelve hours, a plurality of hours, one day, a plurality of days, one week, a plurality of weeks, one month, a plurality of months, one year, a plurality of years, and/or a time period between any two transaction decline time periods provided herein.

In step 606, the heuristics model and decision tree model output are processed by the decision tree model located in the application server 102 to generate a structured narrative. The structured narrative, for example, may be constructed by the CPU 210 of the application server 102 by synthesizing the decision tree model output with the heuristics model. The structured narrative, for example, may comprise the heuristics model, decision tree model output, real-time data, processed real-time data, historical data, processed historical data, assessment factors, and/or transaction attributes. Predictive performance feedback may dynamically adjust the structured narrative to improve accuracy of the prediction by updating transaction patterns and fraud tactics. The structured narrative, for example may comprise one or more heuristics model features. The structured narrative, for example may comprise one or more: IP addresses, decision tree risk levels, heuristics model risk levels, geographical discrepancies, payment method details, merchant categories, transaction declines per a time period, failed email validations, user agent diversities, changes in payment method per a time period, and/or decline patterns.

In step 608, the structured narrative is provided to the predictive server 104. The structured narrative, for example, may be provided by the network interface 200 of the application server 102 to the network interface 300 of the predictive server 104. The predictive server 104, for example, may comprise a transformer network and a predictive risk model. The transformer network, for example, may comprise one transformer network layer, and/or a plurality of transformer network layers.

The structured narrative, for example, may be pre-processed by the CPU 310 of the predictive server 104 using a structured narrative pre-processing process. The structured narrative pre-processing process, for example, may comprise one or more steps from the group consisting of tokenizing the structured narrative, transforming the structured narrative, vectorizing the structured narrative, and/or contextualizing the structured narrative to generate one or more contextual embeddings.

The tokenizing of the structured narrative, for example, may comprise parsing the structured narrative into one or more discrete tokens. The one or more discrete tokens, for example, may comprise one or more heuristics model features. The one or more discrete tokens, for example may comprise one or more: IP addresses, decision tree risk levels, heuristics model risk levels, geographical discrepancies, payment method details, merchant categories, transaction declines per a time period, failed email validations, user agent diversities, changes in payment method per a time period, and/or decline patterns. The transforming of the structured narrative, for example, may comprise converting the one or more discrete tokens into one or more continuous vectors. The one or more continuous vectors, for example, may comprise one or more semantic relationships. The one or more semantic relationships, for example, may comprise one or more associations between one or more heuristics model features. The one or more semantic relationships, for example, may comprise one or more associations between one or more: IP addresses, decision tree risk levels, heuristics model risk levels, geographical discrepancies, payment method details, merchant categories, transaction declines per a time period, failed email validations, user agent diversities, changes in payment method per a time period, and/or decline patterns. For example, a semantic relationship may comprise an association between one or more: decision tree risk levels and/or heuristics model risk levels. The vectorizing of the structured narrative, for example, may comprise translating one or more discrete tokens into high-dimensional vectors. The high-dimensional vectors, for example, may comprise one dimension, five dimensions, twenty-five dimensions, fifty dimensions, one hundred dimensions, two hundred dimensions, five hundred dimensions, one thousand dimensions, a plurality of dimensions, and/or a dimension between any two dimensions provided herein. The one or more dimensions of the high-dimensional vectors, for example, may comprise one or more: semantic characteristics and/or associations. The contextualizing of the structured narrative to generate one or more contextual embeddings, for example, may comprise one or more steps from the group consisting of weighing discrete tokens using an attention mechanism, aggregating the discrete tokens, and/or refining the discrete tokens by the one or more layers of the transformation network.

In step 610, a prediction is generated by processing the structured narrative using the predictive risk model located in the predictive server 104. The prediction generation process, for example, may comprise building a vector model. The vector model building process, for example, may comprise one or more steps from the group consisting of processing sequential layers of the structured narrative, processing the structured narrative using a self-attention mechanism, and/or transforming layers of the structured narrative. In step 612, the prediction and structured narrative are processed by the CPU 210 of the application server 102 to generate a decision. In step 614, the decision is provided to the device 110. The decision, for example, may be provided by the network interface 200 of the application server 102 to the device 110.

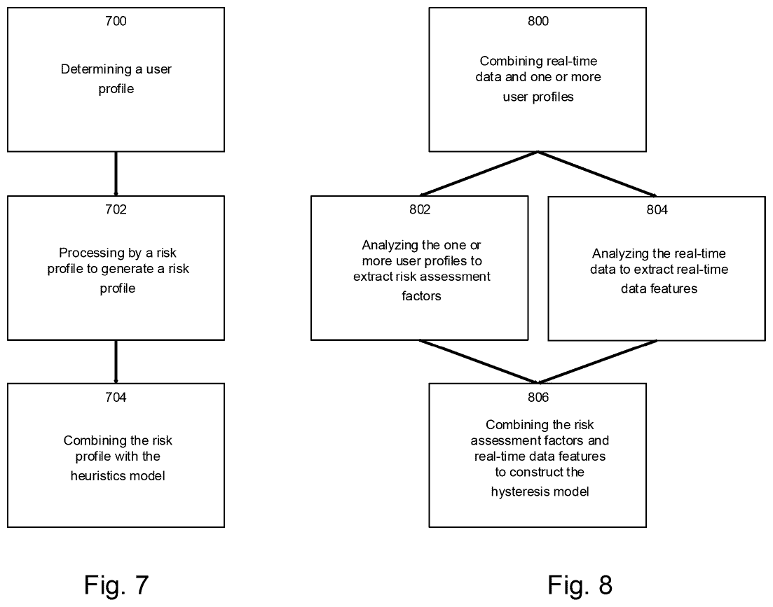

Referring to FIG. 7, one or more risk profile inputs, for example, are generated and stored in a database 230 of the application server 102. In step 700, a user profile, is determined by creating a new user profile from identity data, of the real-time data, or the identity data is matched to an existing user profile stored in a database 230 of the application server 102. The fraud detection system, for example, may verify real-time data against the existing user profile database to check for an existing user profile. The fraud detection system, for example, may verify one or more IP addresses against the existing user profile database to check for an existing user profile. The fraud detection system, for example, may verify one or more payment method specifics (including wallet addresses for cryptocurrencies, routing numbers for ACH, etc.), cardholder names, and authenticated sessions across channels to check for an existing user profile. In step 702, a risk profile is generated from processing the real-time data, identity data, historical data, and the user profile by a risk profiler. A risk profile, for example, may comprise a risk level. A risk level, for example, may comprise a low risk level, a medium risk level, and/or a high risk level. A risk level, for example, may comprise a risk level zero, a risk level one, a risk level two, and/or a risk level three. A risk level, for example, may comprise a green risk level, a yellow risk level, an orange risk level, and/or a red risk level. In step 704, the risk profile is combined with the heuristics model. The risk profiler may consider different real-time data for different payment channels.

The real-time data may be processed. The real-time data, for example, may be processed by determining a source of the real-time data using a source detector and providing a source-rule set based on the source to the application server 102 of the integrated decision engine 100. The source, for example, may comprise one or more: eCommerce sources, point of sale (POS) sources, ACH sources, FedNow sources. Real-time data features, for example, may be extracted based upon the source. Real-time data features, for example, may differ between sources. The real-time data, for example, may be mapped to different rulesets based upon the source, payment channel, and/or high-level channel. The real-time data, for example, may be processed by cleaning the real-time data. The real-time data, for example, may be processed by transforming the real-time data. The real-time data, for example, may be processed by extracting features from the real-time data.

Referring to FIG. 8, a hysteresis model, for example, is constructed and located in the CPU 210 of the application server 102. In step 800, real-time data and one or more user profiles are combined. In step 802, the one or more user profiles are analyzed to extract risk assessment factors based, in part, upon historical data. The historical data, for example, may comprise historical transaction data, historical transaction amount data, historical authorization data, historical primary account number (PAN), and/or historical merchant data. In step 804, the real-time data is analyzed to extract real-time data features. In step 806, the risk assessment factors and real-time data features are combined to construct the hysteresis model. If the real-time data is mapped to a ruleset, then, for example, the ruleset may have its rules applied to the transaction data. Applying the rules to the transaction data may for example comprise, checking the transaction against predefined fraud indicators within the ruleset. The predefined fraud indicators, for example, may comprise transaction amounts, unusual transaction amounts, time between transactions, unusual time between transactions, rapid succession between transactions, geolocation data, and/or unusual geolocation data. The ruleset and/or the rules of a ruleset may be dynamically adjusted. The dynamic adjustment of the ruleset and/or the rules of a ruleset may, for example, be based upon updates to the hysteresis model, heuristics model, user profile, structured narrative, decision tree model, user profile, and/or integrated decision model.

A hysteresis model risk score may be calculated. The hysteresis model risk score R(t) at any given time t may, for example, be calculated as a weighted sum of hysteresis model features X_{N}(t) and H_{N}(t). For example, one possible formula encapsulating this relationship might be:

$$R ( t ) = {w}_{1} \cdot {X}_{1} ( t ) + {w}_{2} \cdot {X}_{2} ( t ) + {w}_{3} \cdot {H}_{1} ( t ) + {w}_{4} {H}_{2} ( t ) \qquad [ Equation 1 ]$$

Where, X₁(t) and X₂(t) may comprise real-time data, H₁(t) and H₂(t) may comprise historical data, and w₁, w₂, w₃, and w₄, may comprise one or more weights of the hysteresis model. The one or more weights of the hysteresis model, for example, may be assigned a weight value corresponding to each hysteresis model feature. The weight value of a given weight of the hysteresis model may be the same or differ from any other weight of the hysteresis model. The weight value of a given weight of the hysteresis model may be dynamic. The weight value of a given weight of the hysteresis model may, for example, be a weight value of −5.00, −4.00, −3.00, −2.00, −1.00, 0.00, 0.10, 0.20, 0.30, 0.35, 0.40, 0.45, 0.50, 0.60, 0.70, 0.80, 0.90, 1.00, 2.00, 3.00, 4.00, 5.00, and/or a weight value between any two weight values provided herein. The weight value of a given weight of the hysteresis model may, for example, be null. The weight value of a hysteresis model feature may, for example, be the weight value detailed in

TABLE 1
Table 1

| Hysteresis Model Feature | Weight Value |
|---|---|
| Risk Level of the Hysteresis Modell | Dynamic |
| IP Address | Null |
| IP Information | 0.20 |
| Bank Identification Number (BIN) Information | 0.30 |
| Transaction Activity | 0.30 |
| Last Transaction Date | 0.10 |
| Last Escalation Date | 0.40 |
| Last Escalation Reason | 0.40 |
| Last Escalation Risk Level | 0.40 |
| Last Escalation Transaction Activity | 0.40 |
| Number of Hysteresis Model Features | 0.30 |
| Average of Hysteresis Model Features | 0.30 |
| Number of Declined Transactions | 0.40 |
| Number of Approved Transactions | 0.10 |
| Average Transaction Amount | 0.20 |
| Transaction Amount | 0.20 |
| Net Transaction Amount | 0.20 |
| Number of Hysteresis Model Feature Error | 0.20 |
| Number of Errors | 0.20 |
| Number of Sequential Declines | 0.50 |
| Number of Sequential Declines within a Timeframe | 0.40 |
| Number of Diverse Payment Method Declines | 0.40 |
| Post-Approval Decline Patterns | 0.45 |
| Number of New User Declines | 0.50 |
| Number of New User Declines within a Timeframe | 0.50 |
| New User Decline Pattern | 0.50 |
| Number of Email Validation Failures | 0.30 |
| Pattern of Declines | 0.40 |
| Number of Declines | 0.40 |
| Number of Declines within a Timeframe | 0.40 |
| Number of New Payment Methods | 0.35 |
| Pattern of New Payment Methods | 0.35 |
| Approved Status | Dynamic |
| Declined Status | Dynamic |
| Error Status | Dynamic |
| Payment Method | 0.10 |
| User Agent | 0.10 |
| Authenticated User Identity | 0.20 |
| Member of Merchant Account (MOMA) | 0.10 |
| Merchant Identity | Null |
| Merchant Category Code (MCC) | 0.30 |

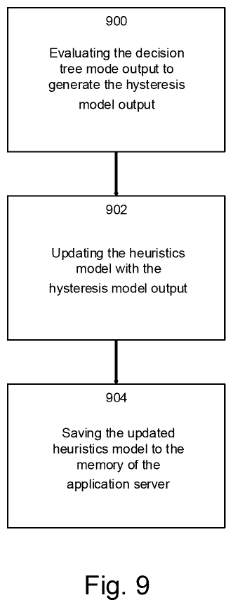

Referring to FIG. 9, one or more hysteresis model outputs, for example are generated. In step 900, the decision tree model output is evaluated by the hysteresis model located in the CPU 210 of the application server 102 to generate a hysteresis model output. In step 902, the heuristics model located in the CPU 210 of the application server 102 is updated with the hysteresis model output. In step 904, the heuristics model, updated with the hysteresis model output, is saved to the memory 220 of the application server 102.

The hysteresis model may, for example, be dynamically evaluated. The dynamic evaluation of the hysteresis model may comprise evaluating risk level of the hysteresis model. The dynamic evaluation of the hysteresis model may comprise verifying the hysteresis model contextually. The dynamic evaluation of the hysteresis model may comprise analyzing a trend in the hysteresis model. Analyzing a trend in the hysteresis model may comprise one or more steps from the group consisting of recognizing a pattern, generating a transformer prediction decision by providing the pattern to the transformer network of the predictive server, generating a decision tree prediction decision by providing the pattern to a decision tree predictor in the CPU of the application server, combining the transformer prediction decision and the decision tree prediction decision using a decision interpreter to generate a trend decision, comprising an escalating trend decision, or a non-escalating trend decision, wherein the escalating trend decision applies a bias to a risk level action, in the processing of the heuristics model and the prediction by the CPU of the application server, and wherein the non-escalating trend decision applies the risk level action, in the processing of the heuristics model and the prediction by the CPU of the application server.

The predictive risk model, for example, may comprise a trained risk model. The trained risk model, for example, may be generated by a method comprising transmitting an output from a Generational Adversarial Network (GAN) located on a simulated data server to a simulated data on the simulated data server to generate a simulated data server output. Generating the trained risk model continues by inputting the simulated data server output into a training dataset on a model training server and pre-processing the training dataset to generate a pre-processed training dataset. Then, the pre-processed training dataset is batched with processed data by a CPU of the model training server to generate a batched dataset. The batched dataset is transmitted to a transformer training engine located on the Graphics Processing Unit (GPU) of the model training server. The batched dataset is processed by the transformer training engine located on the GPU of the model training server to generate an epoch of a model. Processing the epoch of the model, for example, may comprise generating the trained risk model, transmitting the trained risk model to the database of the predictive server, and combining the trained risk model with the predictive risk model.

The simulated data server output, for example, may be generated by loading historical data to a historical training dataset located on the simulated data server. Then, performing data pre-processing on the historical training dataset by the CPU of the simulated data server to generate a pre-processed training dataset. Processed data may be transmitted from a memory of the simulated data server to the CPU of the model training server. The processed data and pre-processed training dataset, for example, may be batched by the CPU of the simulated data server to generate a batched dataset of the simulated data server. The batched dataset of the simulated data server, for example, may be transmitted to a GPU of the simulated data server. A GAN located on the GPU of the simulated data server may process the batched dataset by to generate an output from the GAN located on the simulated data server. The output from the located on the simulated data server, for example, may then be transmitted to a simulated data on the simulated data server to generate the simulated data server output.

The GAN located on the simulated data server, for example, may comprise a GAN regularization engine. The GAN regularization engine, for example, may comprise a discriminator and a generator. The GAN located on the simulated data server, for example, may be trained by a method comprising one or more of the steps consisting of processing historical transaction data on a data pre-processing engine to generate a pre-processed historical transaction dataset, refining the pre-processed historical transaction dataset by the discriminator to generate a refined GAN regularization data engine, generating a simulated data set by the generator of the GAN regularization engine, repeating the refining by the discriminator on the simulated data and generation of simulated data by generator until a high quality simulated transaction dataset is output by the GAN, transmitting the high quality simulated transaction dataset to the transformer network, processing the high quality simulated transaction dataset to generate a simulated transformer prediction, providing the simulated transformer prediction to the data pre-processing engine, and/or performing data pre-processing on historical transaction data and the simulated transformer prediction repeating the GAN located on the simulated data server training process using a feedback loop.

A transformer training process, for example, may comprise transmitting the high-quality simulated transaction dataset to the model training server performing data pre-processing on the high quality simulated transaction dataset to generate a pre-processed simulated transaction dataset. The pre-processed simulated transaction dataset, for example, may be transmitted to a training model of the transformer training engine located on the GPU of the model training server to perform a transformer training engine process. Repeating the transformer training engine process until the target of the transformer training engine is reached, then transmitting the updated training model to the predictive risk model of the predictive server. The prediction from the predictive server, for example, may be generated by a method comprising processing the structure narrative by the CPU of the predictive server by applying the predictive server comprising the updated training model, providing the prediction to the application server, processing the structured narrative and the prediction by the CPU of the application server to generate the decision, performing an outcome analysis on the decision to generate an outcome analysis output, and/or performing data pre-processing on the high quality simulated transaction dataset and the outcome analysis output repeating the transformer training process using a transformer training process feedback loop.

The transformer training engine process, for example, may comprise passing forward the pre-processed simulated transaction dataset from the training model to one or more layers of the transformer training engine. An output, for example, may be generated from the one or more layers of the transformer training engine. The output, for example, may be compared with the one or more layers against a target of the transformer training engine to calculate a loss. An optimized backpropagation may be generated an optimized backpropagation by inputting the loss into an optimizer. Backpropagating the optimized backpropagation to one or more weights of the transformer training engine, for example, may generate one or more updated weights. The training model of the transformer training engine, for example, may be updated with the one or more updated weights to generate an updated training model

The hysteresis model output, for example may be processed, before updating the heuristics model by one or more steps from the group consisting of: cleaning the hysteresis model output; tokenizing the hysteresis model output; transforming the hysteresis model output; and/or vectorizing the hysteresis model output.

Generating the prediction by processing the structured narrative using the predictive risk model located in the predictive server, for example, may comprise building a vector model by one or more steps from the group consisting of: processing sequential layers of the structured narrative; processing the structured narrative using a self-attention mechanism; and/or transforming layers of the structured narrative.

Processing the decision to generate response by one or more steps from the group consisting of: decoding the decision; interpreting the decision; thresholding the decision; applying rules to the decision; and/or summarizing the decision.

A final decision, for example, may comprise an escalating final decision, a non-escalating final decision, and/or a de-escalating final decision. The final decision, for example, may be generated by the integrated decision engine by a method comprising evaluating a weighted decision tree decision against a weighted transformer network decision, by a method comprising comparing a weight of the weighted decision tree decision against a weight of the weighted transformer network decision, providing the final decision to the device.

The weighted decision tree decision, for example, may be generated by a method comprising transmitting the real-time data to the hysteresis model, generating a real-time data hysteresis model output by processing the real-time data in the hysteresis model located in the CPU of the application server, processing the real-time data hysteresis model output by applying decision tree analysis to generate the weighted decision tree decision.

The weighted transformer network decision, for example, may be generated by a method comprising transmitting the weighted decision tree decision to the heuristics model, generating a weighted decision heuristics model output by processing the weighted decision tree decision in the heuristics model located in the CPU of the application server, transmitting the weighted decision heuristics model output to the transformer network of the predictive server, and/or processing the weighted decision heuristics model output by applying transformer network analysis to generate the weighted transformer network decision. The weight of the weighted decision tree decision, for example, may be generated by comparing the weighted decision tree decision to the decision. The weight of the weighted decision tree decision, for example, may be generated by comparing the weighted decision tree decision to the decision.

Applying a risk level action to the risk level of the risk profile, wherein the risk level action comprises increasing, decreasing, or maintaining the risk level. Applying a risk level action, for example, may comprise a method of transmitting the final decision to the risk profile in the database of the application server, comparing the final decision to the risk profile, and/or generating the risk level action.

The decision from the application server, for example, may be provided to the device. The decision, for example, may comprise a decision action, wherein the decision action comprises allowing, quarantining, or blocking the transaction, and increasing or decreasing the risk level of the risk profile changes the decision action.

The integrated decision engine, for example, may be evaluated by generating a feedback dataset; integrating the feedback dataset by generating an integrated decision engine update; and/or adjusting the integrated decision engine using the decision engine.

The feedback dataset, for example, may be generated by a method comprising comparing the final decision, weighted decision tree decision, and weighted transformer network decision to determine if the final decision was accurate. A subsequent transaction comprising a subsequent decision or a subsequent final decision, for example, may be compared to the final decision, weighted decision tree decision, and/or weighted transformer network decision to determine if the subsequent decision or subsequent final decision was accurate.

The integrated decision engine, for example, may be updated may be generated by a method comprising labelling the feedback dataset, curating the feedback dataset, performing data pre-processing on the feedback dataset, augmenting the training dataset on the model training server; and/or adjusting the integrated decision engine using the decision engine.

The integrated decision engine, for example, may be adjusted using the decision engine update by a method comprising adjusting the weight of the weighted decision tree decision, adjusting the weight of the weighted transformer network decision, and/or retraining the model.

The pattern, for example, may comprise one or more blocks with a low amount, one or more blocks with a high amount, a plurality of blocks on a plurality of devices, and/or one or more blocks.

Constructing the heuristics model, for example, may comprise generating a set of heuristics model features, wherein the set of heuristics model features comprises a transaction geolocation, a merchant location, a card issuing location, an email rejection amount, an escalation reason, a current risk level, or a number of order items.

1. A computer-implemented method of real-time fraud prevention, using a fraud prevention system on a transaction, comprising:
accessing real-time data from a device, by a central processing unit (CPU) of an application server of an integrated decision engine, from a device;
processing a risk profile input and the real-time data by a decision tree model located in the application server to generate a decision tree model output;
constructing a heuristics model by the CPU of the application server by synthesizing the decision tree model output with historical data;
processing the heuristics model and decision tree model output by the decision tree model located in the application server to generate a structured narrative;
providing the structured narrative from the application server to a predictive server comprising a transformer network and a predictive risk model via a network interface;
generating a prediction by processing the structured narrative using the predictive risk model located in the predictive server;
processing the structured narrative and the prediction by the CPU of the application server to generate a decision; and
providing the decision to the device.

2. The computer-implemented method according to claim 1, comprising:
evaluating the decision tree model output by a hysteresis model located in the CPU of the application server to generate a hysteresis model output;
updating the heuristics model located in the CPU of the application server, with the hysteresis model output; and
saving the heuristics model to a memory of the application server.

3. The computer-implemented method according to claim 2, comprising processing the real-time data by one or more steps from the group consisting of
determining a source of the real-time data using a source detector and providing a source rule-set based on the source to the application server of the integrated decision engine,
cleaning the real-time data,
transforming the real-time data, and
extracting features from the real-time data.

4. The computer-implemented method according to claim 3, wherein:
the real-time data comprises identity data; and
the risk profile input is generated by a method comprising
determining a user profile by creating a new user profile from the identity data or matching the identity data to an existing user profile stored in a database of the application server,
processing the real-time data, identity data, historical data, and the user profile by a risk profiler to generate a risk profile, wherein the risk profile comprises a risk level, wherein the risk level comprises a low risk level, a medium risk level, or a high risk level, and
combining the risk profile and the heuristics model.

5. The computer-implemented method according to claim 4, comprising dynamically evaluating the hysteresis model by one or more steps from the group consisting of:
evaluating a risk level of the hysteresis model;
verifying the hysteresis model contextually; and
analyzing a trend in the hysteresis model by a method comprising:
recognizing a pattern,
generating a transformer prediction decision by providing the pattern to the transformer network of the predictive server,
generating a decision tree prediction decision by providing the pattern to a decision tree predictor in the CPU of the application server,
combining the transformer prediction decision and the decision tree prediction decision using a decision interpreter to generate a trend decision, comprising an escalating trend decision, or a non-escalating trend decision,
wherein the escalating trend decision applies a bias to a risk level action, in the processing of the heuristics model and the prediction by the CPU of the application server, and
wherein the non-escalating trend decision applies the risk level action, in the processing of the heuristics model and the prediction by the CPU of the application server.

6. The computer-implemented method according to claim 5, wherein the predictive risk model comprises a trained risk model, wherein the trained risk model is generated by a method comprising:
transmitting an output from a Generational Adversarial Network (GAN) located on a simulated data server to a simulated data on the simulated data server to generate a simulated data server output;
inputting the simulated data server output into a training dataset on a model training server;
pre-processing the training dataset to generate a pre-processed training dataset;
batching the pre-processed training dataset with processed data by a CPU of the model training server to generate a batched dataset;
transmitting the batched dataset to a transformer training engine located on the Graphics Processing Unit (GPU) of the model training server;
processing the batched dataset by the transformer training engine located on the GPU of the model training server to generate an epoch of a model;
processing the epoch of the model to generate the trained risk model;
transmitting the trained risk model to the database of the predictive server; and
combining the trained risk model with the predictive risk model.

7. The computer-implemented method according to claim 6, wherein the simulated data server output is generated by a method comprising:
loading historical data to a historical training dataset located on the simulated data server;
performing data pre-processing on the historical training dataset by the CPU of the simulated data server to generate a pre-processed training dataset;
transmitting processed data from a memory of the simulated data server to the CPU of the model training server;
batching the processed data and pre-processed training dataset by the CPU of the simulated data server to generate a batched dataset of the simulated data server;
transmitting the batched dataset of the simulated data server to a GPU of the simulated data server;
processing the batched dataset by a GAN located on the GPU of the simulated data server to generate an output from the GAN located on the simulated data server; and
transmitting the output from the located on the simulated data server to a simulated data on the simulated data server to generate the simulated data server output.

8. The computer-implemented method according to claim 7, wherein the GAN located on the simulated data server comprises a GAN regularization engine, wherein the GAN regularization engine comprises a discriminator and a generator, and the GAN located on the simulated data server is trained by a method comprising:
processing historical transaction data on a data pre-processing engine to generate a pre-processed historical transaction dataset;
refining the pre-processed historical transaction dataset by the discriminator to generate a refined GAN regularization data engine;
generating a simulated data set by the generator of the GAN regularization engine;
repeating the refining by the discriminator on the simulated data and generation of simulated data by generator until a high quality simulated transaction dataset is output by the GAN;
transmitting the high quality simulated transaction dataset to the transformer network;
processing the high quality simulated transaction dataset to generate a simulated transformer prediction;
providing the simulated transformer prediction to the data pre-processing engine;
performing data pre-processing on historical transaction data and the simulated transformer prediction; and
repeating the GAN located on the simulated data server training process using a feedback loop.

9. The computer-implemented method according to claim 8, comprising:
performing a transformer training process by a method comprising
transmitting the high quality simulated transaction dataset to the model training server,
performing data pre-processing on the high quality simulated transaction dataset to generate a pre-processed simulated transaction dataset,
transmitting the pre-processed simulated transaction dataset to a training model of the transformer training engine located on the GPU of the model training server to perform a transformer training engine process,
repeating the transformer training engine process until the target of the transformer training engine is reached and then transmitting the updated training model to the predictive risk model of the predictive server,
generating the prediction from the predictive server by a method comprising processing the structure narrative by the CPU of the predictive server by applying the predictive server comprising the updated training model,
providing the prediction to the application server,
processing the structured narrative and the prediction by the CPU of the application server to generate the decision,
performing an outcome analysis on the decision to generate an outcome analysis output, and
performing data pre-processing on the high quality simulated transaction dataset and the outcome analysis output; and
repeating the transformer training process using a transformer training process feedback loop.

10. The computer-implemented method according to claim 9, wherein the transformer training engine process comprises:
passing forward the pre-processed simulated transaction dataset from the training model to one or more layers of the transformer training engine;
generating an output from the one or more layers of the transformer training engine;
comparing the output from the one or more layers against a target of the transformer training engine to calculate a loss;
generating an optimized backpropagation by inputting the loss into an optimizer;
backpropagating the optimized backpropagation to one or more weights of the transformer training engine to generate one or more updated weights; and
updating the training model of the transformer training engine with the one or more updated weights to generate an updated training model.

11. The computer-implemented method according to claim 10, comprising processing the hysteresis model output before updating the heuristics model by one or more steps from the group consisting of:
cleaning the hysteresis model output;
tokenizing the hysteresis model output;
transforming the hysteresis model output; and
vectorizing the hysteresis model output.

12. The computer-implemented method according to claim 11, wherein generating the prediction by processing the structured narrative using the predictive risk model located in the predictive server comprises building a vector model by one or more steps from the group consisting of:
processing sequential layers of the structured narrative;
processing the structured narrative using a self-attention mechanism; and
transforming layers of the structured narrative.

13. The computer-implemented method according to claim 12, comprising processing the decision to generate response by one or more steps from the group consisting of:
decoding the decision;
interpreting the decision;
thresholding the decision;
applying rules to the decision; and
summarizing the decision.

14. The computer-implemented method according to claim 13, comprising:
generating a final decision, wherein the final decision comprises an escalating final decision, a non-escalating final decision, or a de-escalating final decision, generated by the integrated decision engine by a method comprising
evaluating a weighted decision tree decision against a weighted transformer network decision by a method comprising comparing a weight of the weighted decision tree decision against a weight of the weighted transformer network decision, and
providing the final decision to the device.

15. The computer-implemented method according to claim 14, wherein the weighted decision tree decision is generated by a method comprising:
transmitting the real-time data to the hysteresis model;
generating a real-time data hysteresis model output by processing the real-time data in the hysteresis model located in the CPU of the application server; and
processing the real-time data hysteresis model output by applying decision tree analysis to generate the weighted decision tree decision.

16. The computer-implemented method according to claim 15 wherein the weighted transformer network decision is generated by a method comprising:
transmitting the weighted decision tree decision to the heuristics model;
generating a weighted decision heuristics model output by processing the weighted decision tree decision in the heuristics model located in the CPU of the application server;
transmitting the weighted decision heuristics model output to the transformer network of the predictive server; and
processing the weighted decision heuristics model output by applying transformer network analysis to generate the weighted transformer network decision.

17. The computer-implemented method according to claim 16, wherein the weight of the weighted decision tree decision is generated by comparing the weighted decision tree decision to the decision.

18. The computer-implemented method according to claim 17, comprising applying a risk level action to the risk level of the risk profile, wherein the risk level action comprises increasing, decreasing, or maintaining the risk level, by a method comprising:
transmitting the final decision to the risk profile in the database of the application server;
comparing the final decision to the risk profile; and
generating the risk level action.

19. The computer-implemented method according to claim 18, comprising providing the decision from the application server to the device comprises a decision action, wherein:
the decision action comprises allowing, quarantining, or blocking the transaction; and
increasing or decreasing the risk level of the risk profile changes the decision action.

20. The computer-implemented method according to claim 19, comprising:
evaluating the integrated decision engine by generating a feedback dataset;
integrating the feedback dataset by generating an integrated decision engine update; and
adjusting the integrated decision engine using the decision engine.

21. The computer-implemented method according to claim 20, wherein the feedback dataset is generated by a method comprising:
comparing the final decision, weighted decision tree decision, and weighted transformer network decision to determine if the final decision was accurate; and
comparing a subsequent transaction comprising a subsequent decision or a subsequent final decision to the final decision, weighted decision tree decision, and weighted transformer network decision to determine if the subsequent decision or subsequent final decision were accurate.

22. The computer-implemented method according to claim 21, wherein the integrated decision engine update is generated by a method comprising:
labelling the feedback dataset;
curating the feedback dataset;
performing data pre-processing on the feedback dataset; and
augmenting the training dataset on the model training server.

23. The computer-implemented method according to claim 22, wherein the integrated decision engine is adjusted using the decision engine update by a method comprising:
adjusting the weight of the weighted decision tree decision;
adjusting the weight of the weighted transformer network decision; and
retraining the model.

24. The computer-implemented method according to claim 23, comprising determining the source by the source detector, wherein the source comprises a Point-of-Sale (POS) source or an E-commerce source.

25. The computer-implemented method according to claim 24, wherein the pattern comprises one or more blocks with a low amount, one or more blocks with a high amount, a plurality of blocks on a plurality of devices, or one or more blocks.

26. The computer-implemented method according to claim 25, wherein constructing the heuristics model comprises generating a set of heuristics model features, wherein the set of heuristics model features comprises a transaction geolocation, a merchant location, a card issuing location, an email rejection amount, an escalation reason, a current risk level, or a number of order items.
